(19) United States
(12) Patent Application Publication
(10) Pub. No.: US 2020/0304200 A1
(43) Pub. Date: Sep. 24, 2020

(54) CONTROL METHOD, TASK AIRCRAFT, CONTROL SIDE, RELAY AIRCRAFT, AND READABLE STORAGE MEDIUM

(71) Applicant: SZ DJI TECHNOLOGY CO., LTD., Shenzhen (CN)

(72) Inventors: Ning MA, Shenzhen (CN); Xiaojun YIN, Shenzhen (CN); Xuke WU, Shenzhen (CN)

(21) Appl. No.: 16/889,310

(22) Filed: Jun. 1, 2020

Related U.S. Application Data
(63) Continuation of application No. PCT/CN2017/114619, filed on Dec. 5, 2017.

(51) Int. Cl. H04B 7/185; H04B 17/309; G05D 1/00; G05D 1/10; B64C 39/02

(52) U.S. Cl. CPC H04B 7/18506; H04B 17/309; G05D 1/0011; B64C 2201/146; B64C 39/024; B64C 2201/027; G05D 1/101

(57) ABSTRACT

A control method, a task aircraft, a control side, a relay aircraft, and a readable storage medium are provided. The task aircraft flies in an initial mode, and the initial mode includes one of a direct mode and a relay mode. In the direct mode, the task aircraft flies under a direct control of a control side; and in the relay mode, the task aircraft flies under a control of instructions of the control side relayed by a relay aircraft. The control method includes: controlling the task aircraft to fly in the direct mode, when a communication quality under the relay mode is lower than a communication quality under the direct mode; or controlling the task aircraft to fly in the relay mode, when a communication quality under the relay mode is greater than a communication quality under the direct mode.

### CROSS-REFERENCE TO RELATED APPLICATION

This application is a continuation of International Application No. PCT/CN2017/114619, filed on Dec. 5, 2017, the entirety of which is incorporated herein by reference.

### TECHNICAL FIELD

The present disclosure generally relates to the field of unmanned aerial vehicle technology and, more particularly, relates to a control method, a task aircraft, a control side, a relay aircraft, and a readable storage medium.

### BACKGROUND

When there is no direct path between a task aircraft and a control side, a task aircraft system using a relay task aircraft to assist communication will have a desired relay effect. However, when the communication link between the control side and the task aircraft has a desired quality, the use of relay task aircraft to assist communication will affect the signal transmission quality between the task aircraft and the control side. The disclosed control method, task aircraft, control side, relay aircraft, and readable storage medium are directed to solve one or more problems set forth above and other problems.

### SUMMARY

One aspect of the present disclosure provides a control method for a task aircraft. The task aircraft flies in an initial mode, and the initial mode includes one of a direct mode and a relay mode. In the direct mode, the task aircraft flies under a direct control of a control side; and in the relay mode, the task aircraft flies under a control of instructions of the control side relayed by a relay aircraft. The control method includes: controlling the task aircraft to fly in the direct mode, when a communication quality under the relay mode is lower than a communication quality under the direct mode; or controlling the task aircraft to fly in the relay mode, when a communication quality under the relay mode is greater than a communication quality under the direct mode.

Another aspect of the present disclosure provides a control method for a control side. The control side communicates with a task aircraft and a relay aircraft. The control side operates in an initial mode, and the initial mode includes one of a direct mode and a relay mode. In the direct mode, the task aircraft is directly controlled to fly by the control side; and in the relay mode, the task aircraft is controlled to fly after being relayed through the relay aircraft. The control method includes controlling the control side to operate in the direct mode, when a communication quality under the relay mode is lower than a communication quality under the direct mode; or controlling the control side to operate in the relay mode, when a communication quality under the direct mode is lower than a communication quality under the relay mode.

Another aspect of the present disclosure provides a control method for a relay aircraft. The relay aircraft communicates with a task aircraft and a control side. The task aircraft flies in an initial mode, and the initial mode includes one of a direct mode and a relay mode. In the direct mode, the task aircraft flies under a direct control of the control side; and in the relay mode, the task aircraft flies under a control of instructions of the control side relayed by the relay aircraft. The control method includes controlling the relay aircraft to relay the instructions of the control side to control the task aircraft to fly, when a communication quality under the relay mode is greater than a communication quality under the direct mode; or controlling the relay aircraft to stop relaying the instructions of the control side, when a communication quality under the relay mode is lower than a communication quality under the direct mode.

Other aspects of the present disclosure can be understood by those skilled in the art in light of the description, the claims, and the drawings of the present disclosure.

### BRIEF DESCRIPTION OF THE DRAWINGS

To more clearly illustrate the embodiments of the present disclosure, the drawings will be briefly described below. The drawings in the following description are certain embodiments of the present disclosure, and other drawings may be obtained by a person of ordinary skill in the art in view of the drawings provided without creative efforts.

FIG. 1 illustrates a schematic flowchart of an exemplary control method for a task aircraft consistent with disclosed embodiments of the present disclosure;

FIG. 2 illustrates a schematic component diagram of an exemplary task aircraft, an exemplary control side, and an exemplary relay aircraft consistent with disclosed embodiments of the present disclosure;

FIG. 3 illustrates a schematic scenario diagram of an exemplary task aircraft, an exemplary control side, and an exemplary relay aircraft consistent with disclosed embodiments of the present disclosure;

FIG. 4 illustrates a schematic flowchart of another exemplary control method for a task aircraft consistent with disclosed embodiments of the present disclosure;

FIG. 5 illustrates a schematic flowchart of another exemplary control method for a task aircraft consistent with disclosed embodiments of the present disclosure;

FIG. 6 illustrates a schematic flowchart of an exemplary control method for a control side consistent with disclosed embodiments of the present disclosure;

FIG. 7 illustrates a schematic flowchart of another exemplary control method for a control side consistent with disclosed embodiments of the present disclosure;

FIG. 8 illustrates a schematic flowchart of another exemplary control method for a control side consistent with disclosed embodiments of the present disclosure;

FIG. 9 illustrates a schematic flowchart of an exemplary control method for a relay aircraft consistent with disclosed embodiments of the present disclosure;

FIG. 10 illustrates a schematic flowchart of another exemplary control method for a relay aircraft consistent with disclosed embodiments of the present disclosure; and

FIG. 11 illustrates a schematic flowchart of another exemplary control method for a relay aircraft consistent with disclosed embodiments of the present disclosure.

### DETAILED DESCRIPTION OF THE DISCLOSURE

Reference will now be made in detail to exemplary embodiments of the disclosure, which are illustrated in the accompanying drawings. Wherever possible, the same reference numbers will be used throughout the drawings to refer to the same or the alike parts. The described embodiments are some but not all of the embodiments of the present disclosure. Based on the disclosed embodiments, persons of ordinary skill in the art may derive other embodiments consistent with the present disclosure, all of which are within the scope of the present disclosure.

Similar reference numbers and letters represent similar terms in the following Figures, such that once an item is defined in one Figure, it does not need to be further discussed in subsequent Figures.

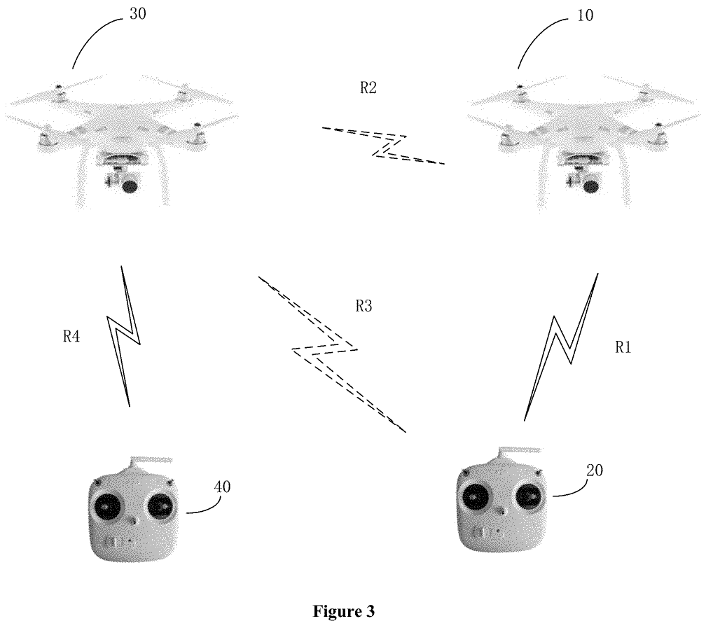

The present disclosure provides a control method for a task aircraft 10. Referring to FIG. 1 and FIG. 3, the task aircraft 10 may fly in an initial mode. The initial mode may include a relay mode and a direct mode. In the direct mod, the task aircraft 10 may fly under a direct control of a control side 20, and in the relay mode, the task aircraft 10 may fly under a control of instructions of the control side 20 relayed by a relay aircraft 30. The control method for the task aircraft 10 may include following.

In S12: Controlling the task aircraft 10 to fly in the direct mode, when a communication quality under the relay mode is lower than a communication quality under the direct mode.

In S14: Controlling the task aircraft 10 to fly in the relay mode, when a communication quality under the relay mode is greater than a communication quality under the direct mode.

The present disclosure further provides a task aircraft 10. The task aircraft 10 may fly in an initial mode. The initial mode may include a relay mode and a direct mode. In the direct mod, the task aircraft 10 may fly under a direct control of a control side 20; and in the relay mode, the task aircraft 10 may fly under a control of instructions of the control side 20 relayed by a relay aircraft 30. The control method for the task aircraft 10 in the disclosed embodiments of the present disclosure may be achieved by the task aircraft 10 in the disclosed embodiments of the present disclosure. The task aircraft 10 may include a flight controller 11. Steps S12 and S14 may be achieved by the flight controller 11.

In other words, the flight controller 11 may be configured to control the task aircraft 10 to fly in the direct mode when the communication quality under the relay mode is lower than the communication quality under the direct mode. Further, the flight controller 11 may be configured to control the task aircraft 10 to fly in the relay mode when the communication quality under the relay mode is greater than the communication quality under the direct mode.

The task aircraft 10 may be a flyable unmanned aerial vehicle. The control side 20 may be a remote controller, a mobile phone, a computer, flying glasses, a bracelet, etc. The relay aircraft 30 may be a fixed relay station, a flyable relay unmanned aerial vehicle, or a relay, etc. The relay may be a vehicle-mounted movable control device, or a relay device independent of the unmanned aerial vehicle and the remote controller, etc.

The communication quality between the task aircraft 10 and the control side 20 may be limited by a flight distance of the task aircraft 10. One of the methods to solve such issue may include using the relay aircraft 30 to relay the instructions of the control side 20 to increase the operating range of the task aircraft 10. However, in some cases, e.g., a case where an obstacle between the relay aircraft 30 and the task aircraft 10 blocks the communication link, the communication quality between the relay aircraft 30 and the task aircraft 10 may be lower than the communication quality between the control side 20 and the task aircraft 10. In view of this, if the relay aircraft 30 is still used to relay the communication signal between the task aircraft 10 and the control side 20, the relay of the communication signal may fail, thereby affecting the communication between the task aircraft 10 and the control side 20.

In the disclosed control method for the task aircraft 10, when the task aircraft 10 flies, the task aircraft 10 may monitor the communication qualities under the direct mode and the relay mode in real time. According to the communication qualities under the direct mode and the relay mode, the task aircraft 10 may select a desired mode to fly, to ensure the stability of the communication between the task aircraft 10 and the control side 20.

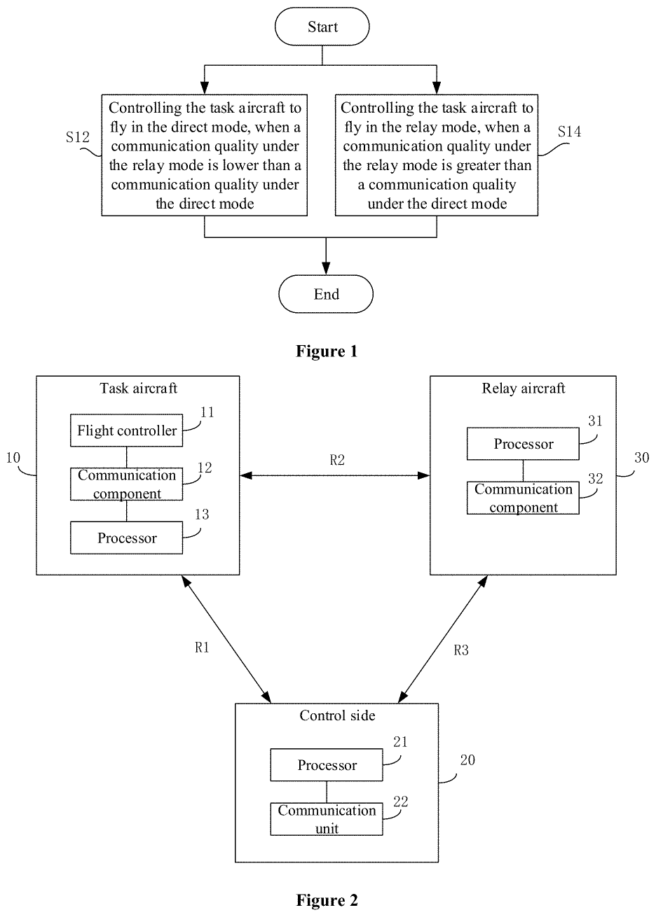

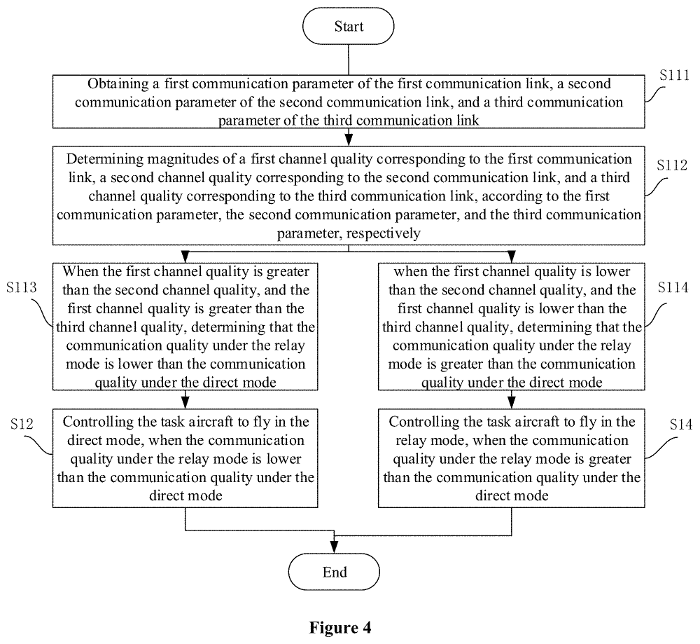

Referring to FIG. 2 and FIG. 4, in certain embodiments, there may be a first communication link R1 between the task aircraft 10 and the control side 20. There may be a second communication link R2 between the task aircraft 10 and the relay aircraft 30. There may be a third communication link R3 between the relay aircraft 30 and the control side 20. The control method for the task aircraft 10 in the present disclosure may further include the following.

In S111: Obtaining a first communication parameter of the first communication link R1, a second communication parameter of the second communication link R2, and a third communication parameter of the third communication link R3.

In S112: Determining the magnitudes of a first channel quality corresponding to the first communication link R1, a second channel quality corresponding to the second communication link R2, and a third channel quality corresponding to the third communication link R3, according to the first communication parameter, the second communication parameter, and the third communication parameter, respectively.

In S113: When the first channel quality is greater than the second channel quality, and the first channel quality is greater than the third channel quality, determining that the communication quality under the relay mode is lower than the communication quality under the direct mode.

In S114: When the first channel quality is lower than the second channel quality, and the first channel quality is lower than the third channel quality, determining that the communication quality under the relay mode is greater than the communication quality under the direct mode.

Referring back to FIG. 2, in certain embodiments, the task aircraft 10 may further include a communication component 12 and a processor 13. Step S111 may be achieved by the communication component 12, and steps S112, S113 and S114 may be achieved by the processor 13.

In other words, the communication component 12 may be configured to obtain the first communication parameter of the first communication link R1, the second communication parameter of the second communication link R2, and the third communication parameter of the third communication link R3. The processor 13 may be configured to determine the magnitudes of the first channel quality corresponding to the first communication link R1, the second channel quality corresponding to the second communication link R2, and the third channel quality corresponding to the third communication link R3, according to the first communication parameter, the second communication parameter, and the third communication parameter, respectively. When the first channel quality is greater than the second channel quality, and the first channel quality is greater than the third channel quality, the processor 13 may determine that the communication quality under the relay mode is lower than the communication quality under the direct mode. When the first channel quality is lower than the second channel quality, and the first channel quality is lower than the third channel quality, the processor 13 may determine that the communication quality under the relay mode is greater than the communication quality under the direct mode.

In one embodiment, when the task aircraft 10 operates in the direct mode, the task aircraft 10 may directly communicate with the control side 20. The task aircraft 10 may receive the flight control instructions sent by the control side 20, and the control side 20 may receive image data sent by the task aircraft 10, the position, flight height, flight speed, flight acceleration, pitch angle of the task aircraft 10, and parameter information of the load carried by the task aircraft 10, etc.

During such period, the task aircraft 10 may be virtually connected to the relay aircraft 30, and the relay aircraft 30 may be virtually connected to the control side 20. In other words, the task aircraft 10 may communicate with the relay aircraft 30, and the relay aircraft 30 may communicate with the control side 20. However, the communication between the task aircraft 10 and the relay aircraft 30 may be merely synchronized at the physical layer, and the communication between the relay aircraft 30 and the control side 20 may be merely synchronized at the physical layer. The communication data may not be transmitted to any other level above the physical layer. In view of this, the communication method synchronized at the physical layer may reduce the processing load of the communication component 12 of the task aircraft 10.

In one embodiment, the first communication parameter, the second communication parameter, and the third communication parameter may be a sounding reference signal (SRS). In view of this, the relay aircraft 30 may send SRS signals to the task aircraft 10 and the control side 20, respectively, and the task aircraft 10 and the control side 20 may receive the SRS signals sent by the relay aircraft 30, respectively. At the same time, the control side 20 may send a SRS signal to the task aircraft 10 and may forward the SRS signal sent by the relay aircraft 30 to the task aircraft 10. Thus, the task aircraft 10 may calculate the first channel quality of the first communication link R1 according to the SRS signal (i.e., the first communication parameter) directly sent by the control side 20. The task aircraft 10 may calculate the second channel quality of the second communication link R2 according to the SRS signal (i.e., the second communication parameter) directly sent by the relay aircraft 30. The task aircraft 10 may calculate the third channel quality of the third communication link R3 according to the SRS signal (i.e., the third communication parameter) sent by the relay aircraft 30 to the control side 20 and forwarded by the control side 20 to the task aircraft.

In certain embodiments, after receiving the SRS signal sent by the relay aircraft 30, the control side 20 may directly calculate the third channel quality of the third communication link R3 and send the third channel quality to the task aircraft 10. In addition, because the task aircraft 10 directly communicates with the control side 20, the first communication parameter may be an instruction signal sent by the control side 20 for controlling the flight of the task aircraft 10. After obtaining the first channel quality, the second channel quality, and the third channel quality, the task aircraft 10 may compare the magnitudes of the three channel qualities. When the first channel quality is simultaneously lower than the second channel quality and the third channel quality, the task aircraft 10 under the direct mode may have a communication quality lower than under the relay mode. In view of this, the task aircraft 10 may switch the operation mode to the relay mode to ensure the stability and reliability of the communication.

When the task aircraft 10 operates in the relay mode, the task aircraft 10 may communicate with the control side 20 through the relay aircraft 30. The relay aircraft 30 may forward the instructions sent by the control side 20 for controlling the flight of the task aircraft 10 to the task aircraft 10, and may forward the image data sent by the task aircraft 10, the position, flight height, flight speed, flight acceleration, pitch angle of the task aircraft 10, and parameter information of the load carried by the task aircraft 10, etc., to the control side 20. During such period, the task aircraft 10 may be virtually connected to the control side 20. In other words, the task aircraft 10 may communicate with the control side 20, but the communication between the task aircraft 10 and the control side 20 may be merely synchronized at the physical layer. The communication data may not be transmitted to any other level above the physical layer. In view of this, the communication method synchronized at the physical layer may reduce the processing load of the communication component 12 of the task aircraft 10.

In one embodiment, the first communication parameter, the second communication parameter, and the third communication parameter may be a sounding reference signal (SRS). In view of this, the relay aircraft 30 may send SRS signals to the task aircraft 10 and the control side 20, respectively. The task aircraft 10 and the control side 20 may receive the SRS signals sent by the relay aircraft 30. At the same time, the control side 20 may send the SRS signal to the task aircraft 10 and may forward the SRS signal sent by the relay aircraft 30 to the task aircraft 10. Thus, the task aircraft 10 may calculate the first channel quality of the first communication link R1 according to the SRS signal (i.e., the first communication parameter) directly sent by the control side 20. The task aircraft 10 may calculate the second channel quality of the second communication link R2 according to the SRS signal (i.e., the second communication parameter) directly sent by the relay aircraft 30. The task aircraft 10 may calculate the third channel quality of the third communication link R3 according to the SRS signal (i.e., the third communication parameter) sent by the relay aircraft 30 to the control side 20 and forwarded by the control side 20 to the task aircraft.

In certain embodiments, because the task aircraft 10 directly communicates with the relay aircraft 30, and the relay aircraft 30 directly communicates with the control side 20, the second communication parameter may be an instruction signal relayed by the relay aircraft 30. The task aircraft 10 may calculate the second channel quality after receiving the instruction signal relayed by the relay aircraft 30. The third communication parameter may be the instruction signal sent by the control side 20. After receiving the instruction signal, the relay aircraft 30 may directly calculate the third channel quality, and may send the third channel quality to the task aircraft 10. After obtaining the first channel quality, the second channel quality, and the third channel quality, the task aircraft 10 may compare the magnitudes of the three channel qualities. When the first channel quality is simultaneously greater than the second channel quality and the third channel quality, the task aircraft 10 under the relay mode may have a communication quality lower than under the direct mode. In view of this, the task aircraft 10 may switch the operation mode to the direct mode to ensure the stability and reliability of the communication.

The channel quality may be at least one of a signal noise ratio (SNR), a reference signal receiving power (RSRP), or a received signal strength indication (RSSI). In other words, the channel quality may be measured according to the signal noise ratio, may be measured according to the reference signal receiving power, or may be measured according to the received signal strength indication. In another embodiment, the channel quality may be measured according to both the signal noise ratio and the reference signal receiving power, may be measured according to both the signal noise ratio and the received signal strength indication, or may be measured according to both the reference signal receiving power and the received signal strength indication. In certain embodiments, the channel quality may be measured according to the signal noise ratio, the reference signal receiving power, and the received signal strength indication. When the channel quality is collectively measured based on more of the signal noise ratio, the reference signal receiving power, and the received signal strength indication, same or different weights may be configured for each participated measurement index. Further, the signal noise ratio, the reference signal receiving power, and the received signal strength indication may be calculated through communication parameters.

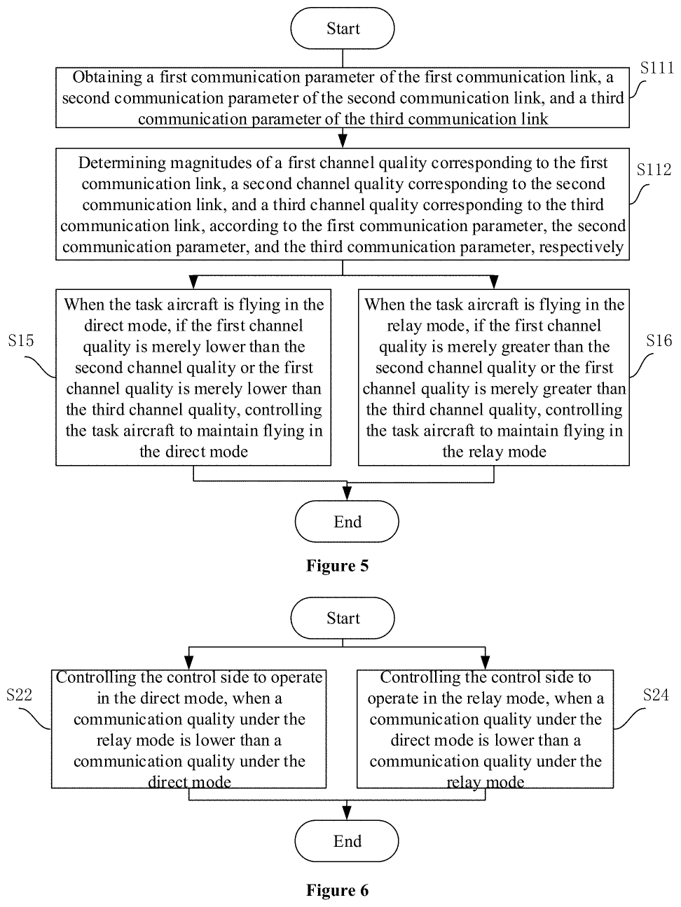

Referring to FIG. 2 and FIG. 5, in certain embodiments, the control method for the task aircraft 10 in the disclosed embodiments of the present disclosure may further include the following.

In S15: When the task aircraft 10 is flying in the direct mode, if the first channel quality is merely lower than the second channel quality or the first channel quality is merely lower than the third channel quality, controlling the task aircraft 10 to maintain flying in the direct mode.

In S16: When the task aircraft 10 is flying in the relay mode, if the first channel quality is merely greater than the second channel quality or the first channel quality is merely greater than the third channel quality, controlling the task aircraft 10 to maintain flying in the relay mode.

Referring to FIG. 2, in certain embodiments, steps S15 and S16 may be achieved by the flight controller 11. In other words, when the task aircraft 10 is flying in the direct mode, if the first channel quality is merely lower than the second channel quality or the first channel quality is merely lower than the third channel quality, the flight controller 11 may be configured to control the task aircraft 10 to maintain flying in the direct mode. When the task aircraft 10 is flying in the relay mode, if the first channel quality is merely greater than the second channel quality or the first channel quality is merely greater than the third channel quality, the flight controller 11 may be configured to control the task aircraft 10 to maintain flying in the relay mode.

In one embodiment, the first channel quality being merely lower than one of the second channel quality and the third channel quality, and the first channel quality being merely greater than one of the second channel quality and the third channel quality may belong to a case where the first channel quality is between the second channel quality and the third channel quality. In view of this, the task aircraft 10 may maintain the original operation mode regardless of whether the task aircraft 10 operates in the direct mode or in the relay mode. Therefore, the task aircraft 10 may be prevented from frequently switching operation mode to cause power consumption, and the task aircraft 10 may be prevented from frequently switching operation mode to increase the processing load of the communication unit 22.

The present disclosure further provides a computer-readable storage medium. The computer-readable storage medium may include a computer program used in combination with an electronic device. The electronic device herein may include the task aircraft 10. The computer program may be executed by the processor 13 to achieve the control method for the task aircraft 10 according to any one of the above-disclosed embodiments.

In one embodiment, the computer program may be executed by the processor 13 to perform the following control method for the task aircraft 10. When the communication quality under the relay mode is lower than the communication quality under the direct mode, the flight controller 11 may be instructed to control the task aircraft 10 to fly in the direct mode. When the communication quality under the relay mode is greater than the communication quality under the direct mode, the flight controller 11 may be instructed to control the task aircraft 10 to fly in the relay mode.

In another embodiment, the computer program may be executed by the processor 13 to perform the following control method for the task aircraft 10.

The communication component 12 may be controlled to obtain a first communication parameter of the first communication link R1, a second communication parameter of the second communication link R2, and a third communication parameter of the third communication link R3.

The magnitudes of a first channel quality corresponding to the first communication link R1, a second channel quality corresponding to the second communication link R2, and a third channel quality corresponding to the third communication link R3 may be determined according to the first communication parameter, the second communication parameter, and the third communication parameter, respectively.

When the first channel quality is greater than the second channel quality, and the first channel quality is greater than the third channel quality, it may be determined that the communication quality under the relay mode is lower than the communication quality under the direct mode.

When the first channel quality is lower than the second channel quality, and the first channel quality is lower than the third channel quality, it may be determined that the communication quality under the relay mode is greater than the communication quality under the direct mode.

Referring to FIG. 3 and FIG. 6, the present disclosure provides a control method for the control side 20. The control side 20 may communicate with the task aircraft 10 and the relay aircraft 30. The control side 20 may operate in an initial mode. The initial mode may include a direct mode and a relay mode. In the direct mode, the task aircraft 10 may be directly controlled to fly by the control side 20; and in the relay mode, the task aircraft 10 may be controlled to fly after being relayed through the relay aircraft 30. The control method for the control side 20 may include the following.

In S22: Controlling the control side 20 to operate in the direct mode, when a communication quality under the relay mode is lower than a communication quality under the direct mode.

In S24: Controlling the control side 20 to operate in the relay mode, when a communication quality under the direct mode is lower than a communication quality under the relay mode.

Referring back to FIG. 2, the present disclosure further provides a control side 20. The control side 20 may communicate with the task aircraft 10 and the relay aircraft 30. The control side 20 may operate in an initial mode. The initial mode may include a direct mode and a relay mode. In the direct mode, the task aircraft 10 may be directly controlled to fly by the control side 20; and in the relay mode, the task aircraft 10 may be controlled to fly after being relayed through the relay aircraft 30.

The control method for the control side 20 in the disclosed embodiments of the present disclosure may be achieved by the control side 20 in the disclosed embodiments of the present disclosure. The control side 20 in the disclosed embodiments of the present disclosure may include a processor 21. Both steps S22 and S24 may be achieved by the processor 21. In other words, when the communication quality under the relay mode is lower than the communication quality under the direct mode, the processor 21 may be configured to control the control side 20 to operate in the direct mode. When a communication quality under the direct mode is lower than a communication quality under the relay mode, the processor 21 may be configured to control the control side 20 to operate in the relay mode.

The task aircraft 10 may be a flyable unmanned aerial vehicle. The control side 20 may be a remote controller, a mobile phone, a computer, flying glasses, a bracelet, etc. The relay aircraft 30 may be a fixed relay station, a flyable relay unmanned aerial vehicle, or a relay, etc. The relay may be a vehicle-mounted movable control device, or a relay device independent of the unmanned aerial vehicle and the remote controller, etc.

The communication quality between the task aircraft 10 and the control side 20 may be limited by a flight distance of the task aircraft 10. One of the methods to solve such issue may include using the relay aircraft 30 to relay the instructions of the control side 20 to increase the operating range of the task aircraft 10. However, in some cases, e.g., a case where an obstacle between the relay aircraft 30 and the task aircraft 10 blocks the communication link, the communication quality between the relay aircraft 30 and the task aircraft 10 may be lower than the communication quality between the control side 20 and the task aircraft 10. In view of this, if the relay aircraft 30 is still configured to relay the communication signal between the task aircraft 10 and the control side 20, the relay of the communication signal may fail, thereby affecting the communication between the task aircraft 10 and the control side 20.

In the disclosed control method for the control side 20, when controlling the task aircraft 10 to fly, the control side 20 may monitor the communication qualities under the direct mode and the relay mode in real time. According to the communication qualities under the direct mode and the relay mode, the control side 20 may select a desired mode to operate, to ensure the stability of the communication between the task aircraft 10 and the control side 20.

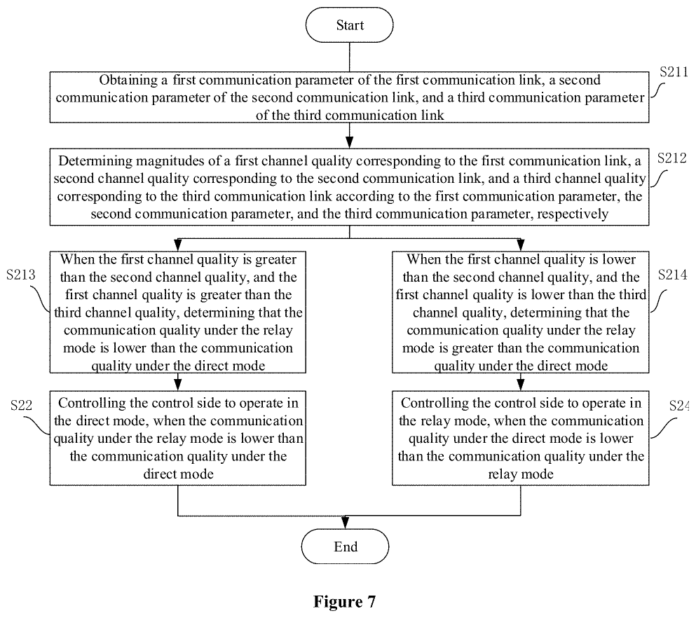

Referring to FIG. 2 and FIG. 7, in certain embodiments, there may be a first communication link R1 between the task aircraft 10 and the control side 20. There may be a second communication link R2 between the task aircraft 10 and the relay aircraft 30. There may be a third communication link R3 between the relay aircraft 30 and the control side 20. The control method for the control side 20 in the present disclosure may further include the following.

In S211: Obtaining a first communication parameter of the first communication link R1, a second communication parameter of the second communication link R2, and a third communication parameter of the third communication link R3.

In S212: Determining the magnitudes of a first channel quality corresponding to the first communication link R1, a second channel quality corresponding to the second communication link R2, and a third channel quality corresponding to the third communication link R3, according to the first communication parameter, the second communication parameter, and the third communication parameter, respectively.

In S213: When the first channel quality is greater than the second channel quality, and the first channel quality is greater than the third channel quality, determining that the communication quality under the relay mode is lower than the communication quality under the direct mode.

In S214: When the first channel quality is lower than the second channel quality, and the first channel quality is lower than the third channel quality, determining that the communication quality under the relay mode is greater than the communication quality under the direct mode.

Referring back to FIG. 2, in certain embodiments, the control side 20 may further include a communication unit 22. Step S211 may be achieved by the communication unit 22, and steps S212, S213, and S214 may be achieved by the processor 21.

In other words, the communication unit 22 may be configured to obtain the first communication parameter of the first communication link R1, the second communication parameter of the second communication link R2, and the third communication parameter of the third communication link R3. The processor 21 may be configured to determine the magnitudes of the first channel quality corresponding to the first communication link R1, the second channel quality corresponding to the second communication link R2, and the third channel quality corresponding to the third communication link R3, according to the first communication parameter, the second communication parameter, and the third communication parameter, respectively. When the first channel quality is greater than the second channel quality, and the first channel quality is greater than the third channel quality, the processor 21 may determine that the communication quality under the relay mode is lower than the communication quality under the direct mode. When the first channel quality is lower than the second channel quality, and the first channel quality is lower than the third channel quality, the processor 21 may determine that the communication quality under the relay mode is greater than the communication quality under the direct mode.

In one embodiment, when the control side 20 operates in the direct mode, the control side 20 may directly communicate with the task aircraft 10. The task aircraft 10 may receive the flight control instructions sent by the control side 20, and the control side 20 may receive image data sent by the task aircraft 10, the position, flight height, flight speed, flight acceleration, pitch angle of the task aircraft 10, and parameter information of the load carried by the task aircraft 10, etc. During such period, the task aircraft 10 may be virtually connected to the relay aircraft 30, and the relay aircraft 30 may be virtually connected to the control side 20.

In other words, the task aircraft 10 may communicate with the relay aircraft 30, and the relay aircraft 30 may communicate with the control side 20. However, the communication between the task aircraft 10 and the relay aircraft 30 may be merely synchronized at the physical layer, and the communication between the relay aircraft 30 and the control side 20 may be merely synchronized at the physical layer. The communication data may not be transmitted to any other level above the physical layer. In view of this, the communication method synchronized at the physical layer may reduce the processing load of the communication unit 22 of the control side 20.

In one embodiment, the first communication parameter, the second communication parameter, and the third communication parameter may be a sounding reference signal (SRS). In view of this, the relay aircraft 30 may send SRS signals to the task aircraft 10 and the control side 20, respectively, and the task aircraft 10 and the control side 20 may receive the SRS signals sent by the relay aircraft 30. At the same time, the task aircraft 10 may send the SRS signal to the control side 20, and may forward the SRS signal sent by the relay aircraft 30 to the control side 20. Thus, the control side 20 may calculate the first channel quality of the first communication link R1 according to the SRS signal (i.e., the first communication parameter) directly sent by the task aircraft 10. The control side 20 may calculate the second channel quality of the second communication link R2 according to the SRS signal (i.e., the second communication parameter) sent by the relay aircraft 30 to the task aircraft 10 and forwarded by the task aircraft 10 to the control side 20. The control side 20 may calculate the third channel quality of the third communication link R3 according to the SRS signal (i.e., the third communication parameter) directly sent by the relay aircraft 30.

In certain embodiments, after receiving the SRS signal sent by the relay aircraft 30, the task aircraft 10 may directly calculate the second channel quality of the second communication link R2 and send the second channel quality to the control side 20. In addition, because the control side 20 directly communicates with the task aircraft 10, the first communication parameter may be a signal, e.g., image transmission data, flight parameter, etc., sent by the task aircraft 10 to the control side 20. The control side may calculate the first channel quality according to the signal, e.g., image transmission data and the flight parameter, etc. After obtaining the first channel quality, the second channel quality, and the third channel quality, the control side 20 may compare the magnitudes of the three channel qualities. When the first channel quality is simultaneously lower than the second channel quality and the third channel quality, the control side 20 in direct mode may have a communication quality lower than in the relay mode. In view of this, the control side 20 may switch the operation mode to the relay mode to ensure the stability and reliability of the communication.

When the control side 20 operates in the relay mode, the control side 20 may communicate with the task aircraft 10 through the relay aircraft 30. The relay aircraft 30 may forward the instructions sent by the control side 20 for controlling the flight of the task aircraft 10 to the task aircraft 10, and may forward the image data sent by the task aircraft 10, the position, flight height, flight speed, flight acceleration, pitch angle of the task aircraft 10, and parameter information of the load carried by the task aircraft 10, etc., to the control side 20. During such period, the task aircraft 10 may be virtually connected to the control side 20. In other words, the task aircraft 10 may communicate with the control side 20, but the communication between the task aircraft 10 and the control side 20 may be merely synchronized at the physical layer. The communication data may not be transmitted to any other level above the physical layer. In view of this, the communication method synchronized at the physical layer may reduce the processing load of the communication unit 22 of the control side 20.

In one embodiment, the first communication parameter, the second communication parameter, and the third communication parameter may be a sounding reference signal (SRS). In view of this, the relay aircraft 30 may send SRS signals to the task aircraft 10 and the control side 20, respectively, and the task aircraft 10 and the control side 20 may receive the SRS signals sent by the relay aircraft 30. At the same time, the task aircraft 10 may send the SRS signal to the control side 20 and may forward the SRS signal sent by the relay aircraft 30 to the control side 20. Thus, the control side 20 may calculate the first channel quality of the first communication link R1 according to the SRS signal (i.e., the first communication parameter) directly sent by the task aircraft 10. The control side 20 may calculate the second channel quality of the second communication link R2 according to the SRS signal (i.e., the second communication parameter) sent by the relay aircraft 30 to the task aircraft 10 and forwarded by the task aircraft 10 to the control side. The control side 20 may calculate the third channel quality of the third communication link R3 according to the SRS signal (i.e., the third communication parameter) directly sent by the relay aircraft 30.

In certain embodiments, because the task aircraft 10 directly communicates with the relay aircraft 30, and the relay aircraft 30 directly communicates with the control side 20, the second communication parameter may be a signal, e.g., image transmission data, or flight parameter, etc., sent by the task aircraft 10 to the relay aircraft 30. The relay aircraft 30 may directly calculate the second channel quality according to the signal, e.g., image transmission data, or flight parameter, etc., and may send the second channel quality to the control side 20.

The third communication parameter may be the signal, e.g., image transmission data, or flight parameter, etc., relayed by the relay aircraft 30. After receiving the signal, e.g., image transmission data, or flight parameter, etc., relayed by the relay aircraft 30, the control side 20 may calculate the third channel quality according to the signal. After obtaining the first channel quality, the second channel quality, and the third channel quality, the control side 20 may compare the magnitudes of the three channel qualities. When the first channel quality is simultaneously greater than the second channel quality and the third channel quality, the control side 20 in the relay mode may have a communication quality lower than in the direct mode. In view of this, the control side 20 may switch the operation mode to the direct mode to ensure the stability and reliability of the communication.

The channel quality may be at least one of a signal noise ratio (SNR), a reference signal receiving power (RSRP), or a received signal strength indication (RSSI). In other words, the channel quality may be merely measured according to the signal noise ratio, may be merely measured according to the reference signal receiving power, or may be merely measured according to the received signal strength indication. In another embodiment, the channel quality may be measured according to both the signal noise ratio and the reference signal receiving power, may be measured according to both the signal noise ratio and the received signal strength indication, or may be measured according to both the reference signal receiving power and the received signal strength indication. In certain embodiments, the channel quality may be measured according to the signal noise ratio, the reference signal receiving power, and the received signal strength indication. When the channel quality is collectively measured based on more of the signal noise ratio, the reference signal receiving power, and the received signal strength indication, same or different weights may be configured for each participated measurement index. Further, the signal noise ratio, the reference signal receiving power, and the received signal strength indication may be calculated through communication parameters.

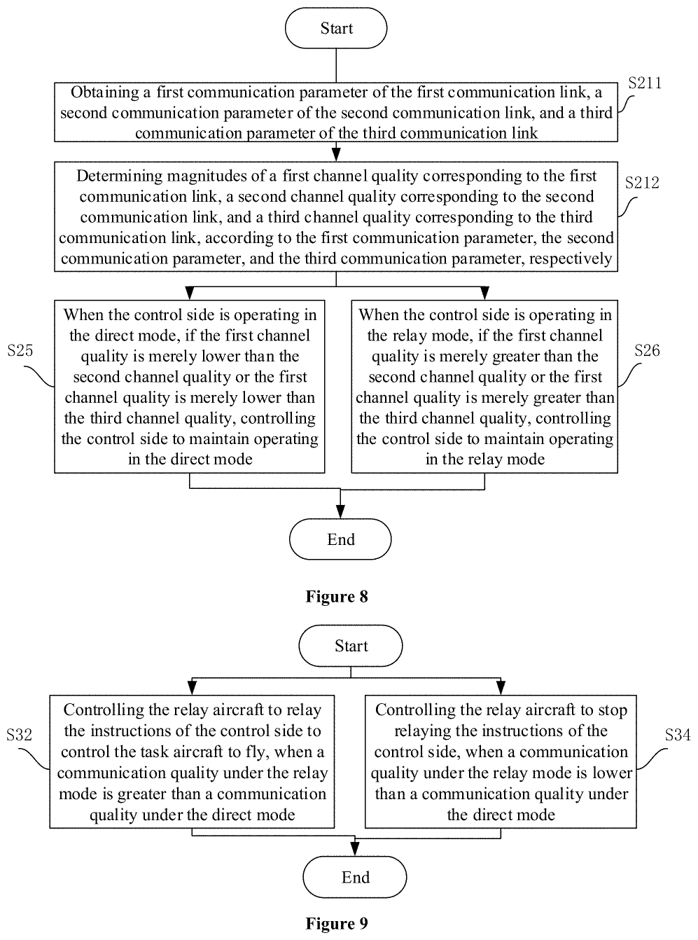

Referring to FIG. 2 and FIG. 8, in certain embodiments, the control method for the control side 20 in the disclosed embodiments of the present disclosure may further include the following.

In S25: When the control side 20 is operating in the direct mode, if the first channel quality is merely lower than the second channel quality or the first channel quality is merely lower than the third channel quality, controlling the control side 20 to maintain operating in the direct mode.

In S26: When the control side 20 is operating in the relay mode, if the first channel quality is merely greater than the second channel quality or the first channel quality is merely greater than the third channel quality, controlling the control side 20 to maintain operating in the relay mode.

Referring to FIG. 2, in certain embodiments, steps S25 and S26 may be achieved by the processor 21. In other words, when the control side 20 is operating in the direct mode, if the first channel quality is merely lower than the second channel quality or the first channel quality is merely lower than the third channel quality, the processor 21 may be configured to control the control side 20 to maintain operating in the direct mode. When the control side 20 is operating in the relay mode, if the first channel quality is merely greater than the second channel quality or the first channel quality is merely greater than the third channel quality, the processor 21 may be configured to control the control side 20 to maintain operating in the relay mode.

In one embodiment, the first channel quality being merely lower than one of the second channel quality and the third channel quality, and the first channel quality being merely greater than one of the second channel quality and the third channel quality may belong to a case where the first channel quality is between the second channel quality and the third channel quality. In view of this, the control side 20 may maintain the original operation mode regardless of whether the control side 20 operates in the direct mode or in the relay mode. Therefore, the control side 20 may be prevented from frequently switching operation mode to cause power consumption, and the control side 20 may be prevented from frequently switching operation mode to increase the processing load of the communication unit 22.

The present disclosure further provides a computer-readable storage medium. The computer-readable storage medium may include a computer program used in combination with an electronic device. The electronic device herein may be the control side 20. The computer program may be executed by the processor 21 to achieve the control method for the control side 20 according to any one of the above-disclosed embodiments.

In one embodiment, the computer program may be executed by the processor 21 to perform the following control method for the control side 20. When the communication quality under the relay mode is lower than the communication quality under the direct mode, the control side 20 may be controlled to operate in the direct mode. When a communication quality under the direct mode is lower than a communication quality under the relay mode, the control side 20 may be controlled to operate in the relay mode.

In another embodiment, the computer program may be executed by the processor 21 to perform the following control method for the control side 20.

The communication unit 22 may be controlled to obtain a first communication parameter of the first communication link R1, a second communication parameter of the second communication link R2, and a third communication parameter of the third communication link R3.

The magnitudes of a first channel quality corresponding to the first communication link R1, a second channel quality corresponding to the second communication link R2, and a third channel quality corresponding to the third communication link R3 may be determined, according to the first communication parameter, the second communication parameter, and the third communication parameter, respectively.

When the first channel quality is greater than the second channel quality, and the first channel quality is greater than the third channel quality, it may be determined that the communication quality under the relay mode is lower than the communication quality under the direct mode.

When the first channel quality is lower than the second channel quality, and the first channel quality is lower than the third channel quality, it may be determined that the communication quality under the relay mode is greater than the communication quality under the direct mode.

Referring to FIG. 2 and FIG. 9, the present disclosure provides a control method for the relay aircraft 30. The relay aircraft 30 may communicate with the task aircraft 10 and the control side 20. The task aircraft 10 may fly in an initial mode. The initial mode may include a relay mode and a direct mode. In the direct mode, the task aircraft 10 may fly under a direct control of the control side 20; and in the relay mode, the task aircraft 10 may fly under a control of instructions of the control side 20 relayed by the relay aircraft 30. The control method for the relay aircraft 30 may include the following.

In S32: Controlling the relay aircraft 30 to relay the instructions of the control side 20 to control the task aircraft 10 to fly, when the communication quality under the relay mode is greater than the communication quality under the direct mode.

In S34: Controlling the relay aircraft 30 to stop relaying the instructions of the control side 20, when the communication quality under the relay mode is lower than the communication quality under the direct mode.

The present disclosure further provides a relay aircraft 30. The relay aircraft 30 may communicate with the task aircraft 10 and the control side 20. The task aircraft 10 may fly in an initial mode. The initial mode may include a relay mode and a direct mode. In the direct mode, the task aircraft 10 may fly under a direct control of the control side 20; and in the relay mode, the task aircraft 10 may fly under a control of instructions of the control side 20 relayed by the relay aircraft 30. The control method for the relay aircraft 30 in the disclosed embodiments of the present disclosure may be achieved by the relay aircraft 30 in the disclosed embodiments of the present disclosure. The relay aircraft 30 in the disclosed embodiments of the present disclosure may include a processor 31. Both steps S32 and S34 may be achieved by the processor 31.

In other words, when the communication quality under the relay mode is greater than the communication quality under the direct mode, the processor 31 may be configured to control the relay aircraft 30 to relay the instructions of the control side 20 to control the task aircraft 10 to fly. When the communication quality under the relay mode is lower than the communication quality under the direct mode, the processor 31 may be configured to control the relay aircraft 30 to stop relaying the instructions of the control side 20.

The task aircraft 10 may be a flyable unmanned aerial vehicle. The control side 20 may be a remote controller, a mobile phone, a computer, flying glasses, a bracelet, etc. The relay aircraft 30 may be a fixed relay station, a flyable relay unmanned aerial vehicle, or a relay, etc. The relay may be a vehicle-mounted movable control device, or a relay device independent of the unmanned aerial vehicle and the remote controller, etc.

The communication quality between the task aircraft 10 and the control side 20 may be limited by a flight distance of the task aircraft 10. One of the methods to solve such issue may include using the relay aircraft 30 to relay the instructions of the control side 20 to increase the operating range of the task aircraft 10. However, in some cases, e.g., a case where an obstacle between the relay aircraft 30 and the task aircraft 10 blocks the communication link, the communication quality between the relay aircraft 30 and the task aircraft 10 may be lower than the communication quality between the control side 20 and the task aircraft 10. In view of this, if the relay aircraft 30 is still configured to relay the communication signal between the task aircraft 10 and the control side 20, the relay of the communication signal may fail, thereby affecting the communication between the task aircraft 10 and the control side 20.

In the disclosed control method for the relay aircraft 30, when the task aircraft 10 is flying, the relay aircraft 30 may monitor the communication qualities under the direct mode and the relay mode in real time. According to the communication qualities under the direct mode and the relay mode, the relay aircraft 30 may select a desired mode to fly, thereby ensuring the relay aircraft 30 to be capable of steady relaying the communication signal between the task aircraft 10 and the control side 20, and ensuring the stability of the communication between the task aircraft 10 and the control side 20.

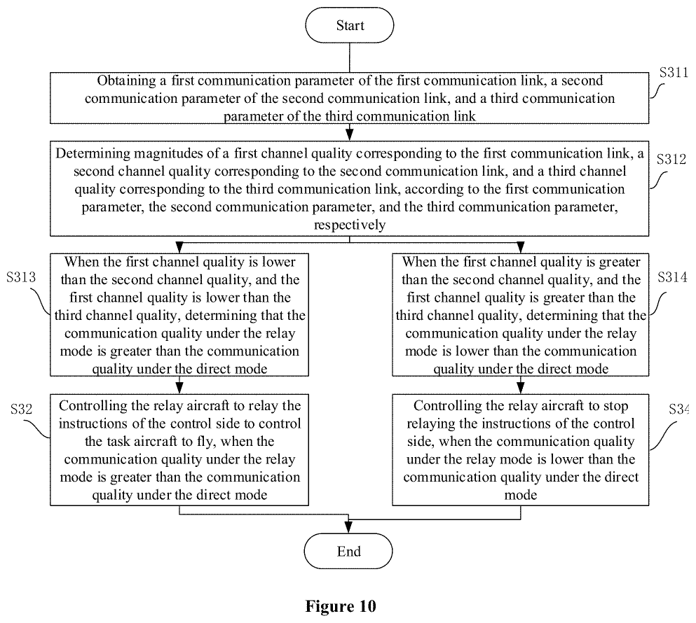

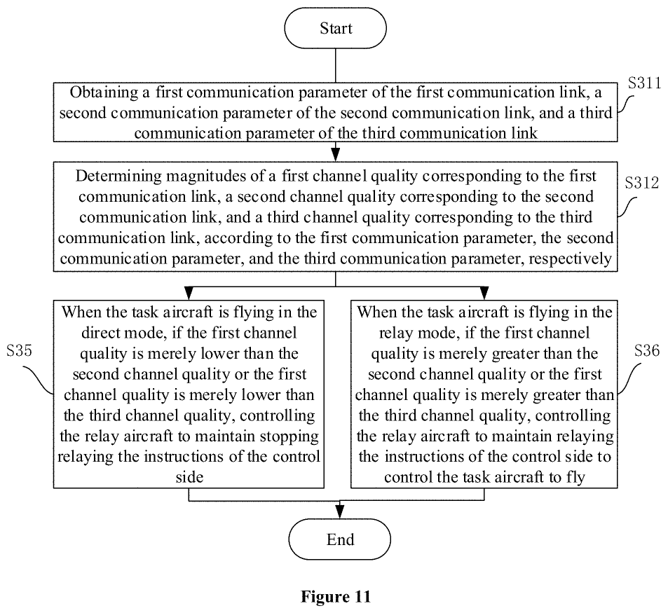

Referring to FIG. 2 and FIG. 10, in certain embodiments, there may be a first communication link R1 between the task aircraft 10 and the control side 20. There may be a second communication link R2 between the task aircraft 10 and the relay aircraft 30. There may be a third communication link R3 between the relay aircraft 30 and the control side 20. The control method for the relay aircraft 30 in the present disclosure may further include the following.

In S311: Obtaining a first communication parameter of the first communication link R1, a second communication parameter of the second communication link R2, and a third communication parameter of the third communication link R3.

In S312: Determining the magnitudes of a first channel quality corresponding to the first communication link R1, a second channel quality corresponding to the second communication link R2, and a third channel quality corresponding to the third communication link R3, according to the first communication parameter, the second communication parameter, and the third communication parameter, respectively.

In S313: When the first channel quality is greater than the second channel quality, and the first channel quality is greater than the third channel quality, determining that the communication quality under the relay mode is lower than the communication quality under the direct mode.

In S314: When the first channel quality is lower than the second channel quality, and the first channel quality is lower than the third channel quality, determining that the communication quality under the relay mode is greater than the communication quality under the direct mode.

Referring back to FIG. 2, in certain embodiments, the relay aircraft 30 may further include a communication component 32. Step S311 may be achieved by the communication component 32, and steps S312, S313, and S314 may be achieved by the processor 31.

In other words, the communication component 32 may be configured to obtain the first communication parameter of the first communication link R1, the second communication parameter of the second communication link R2, and the third communication parameter of the third communication link R3. The processor 31 may be configured to determine the magnitudes of the first channel quality corresponding to the first communication link R1, the second channel quality corresponding to the second communication link R2, and the third channel quality corresponding to the third communication link R3, according to the first communication parameter, the second communication parameter, and the third communication parameter, respectively. When the first channel quality is greater than the second channel quality, and the first channel quality is greater than the third channel quality, the processor 31 may determine that the communication quality under the relay mode is lower than the communication quality under the direct mode. When the first channel quality is lower than the second channel quality, and the first channel quality is lower than the third channel quality, the processor 31 may determine that the communication quality under the relay mode is greater than the communication quality under the direct mode.

In one embodiment, when the task aircraft 10 is operating in the direct mode, the task aircraft 10 may directly communicate with the control side 20. The task aircraft 10 may receive the flight control instructions sent by the control side 20, and the control side 20 may receive image data sent by the task aircraft 10, the position, flight height, flight speed, flight acceleration, pitch angle of the task aircraft 10, and parameter information of the load carried by the task aircraft 10, etc. During such period, the relay aircraft 30 may be virtually connected to the task aircraft 10, and the relay aircraft 30 may be virtually connected to the control side 20. In other words, the relay aircraft 30 may communicate with the task aircraft 10, and the relay aircraft 30 may communicate with the control side 20. However, the communication between the relay aircraft 30 and the task aircraft 10 may be merely synchronized at the physical layer, and the communication between the relay aircraft 30 and the control side 20 may be merely synchronized at the physical layer. The communication data may not be transmitted to any other level above the physical layer. In view of this, the communication method synchronized at the physical layer may reduce the processing load of the communication component 32 of the relay aircraft 30.

In one embodiment, the first communication parameter, the second communication parameter, and the third communication parameter may be a sounding reference signal (SRS). In view of this, the task aircraft 10 and the control side 20 may send SRS signals to the relay aircraft 30, and the relay aircraft 30 may receive the SRS signals sent by the task aircraft 10 and the control side 20. At the same time, the task aircraft 10 may send a SRS signal to the control side 20, and the control side 20 may forward the received SRS signal sent by the task aircraft 10 to the relay aircraft 30. Thus, the relay aircraft 30 may calculate the first channel quality of the first communication link R1 according to the SRS signal (i.e., the first communication parameter) sent by the task aircraft 10 to the control side 20 and forwarded by the control side 20 to the relay aircraft 30. The relay aircraft 30 may calculate the second channel quality of the second communication link R2 according to the SRS signal (i.e., the second communication parameter) directly sent by the task aircraft 10 to the relay aircraft 30. The relay aircraft 30 may calculate the third channel quality of the third communication link R3 according to the SRS signal (i.e., the third communication parameter) directly sent by the control side 20 to the relay aircraft 30.

In certain embodiments, after receiving the SRS signal sent by the task aircraft 10, the control side 20 may directly calculate the first channel quality of the first communication link R1 and send the first channel quality to the relay aircraft 30. In addition, the control side 20 may send the SRS signal to the task aircraft 10, and the task aircraft 10 may forward the SRS signal sent by the control side 20 to the relay aircraft 30. In view of this, the relay aircraft 30 may calculate the first channel quality of the first communication link R1 according to the SRS signal (i.e., the first communication parameter) sent by the control side 20 and forwarded by the task aircraft 10. In another embodiment, the task aircraft 10 may directly calculate the first channel quality of the first communication link R1 according to the SRS signal sent by the control side 20, and may send the first channel quality to the relay aircraft 30.

Moreover, because the task aircraft 10 directly communicates with the control side 20, the first communication parameter may be instruction signals sent by the control side 20 for controlling the flight of the task aircraft 10. The task aircraft 10 may calculate the first channel quality according to the received instruction signals and may forward the first channel quality to the relay aircraft 30. In another embodiment, the first communication parameter may be a signal, e.g., image transmission data, flight parameter, etc., sent by the task aircraft 10 to the control side 20. The control side 20 may calculate the first channel quality according to the received signal, e.g., the image transmission data and the flight parameter, etc., and may forward the first channel quality to the relay aircraft 30.

After obtaining the first channel quality, the second channel quality, and the third channel quality, the relay aircraft 30 may compare the magnitudes of the three channel qualities. When the first channel quality is simultaneously lower than the second channel quality and the third channel quality, the task aircraft 10 in direct mode may have a communication quality lower than in the relay mode. In view of this, the relay aircraft 30 may relay the communication signal between the task aircraft 10 and the control side 20, to ensure the stability and reliability of the communication between the task aircraft 10 and the control side 20.

When the task aircraft 10 is operating in the relay mode, the task aircraft 10 may communicate with the control side 20 through the relay aircraft 30. The relay aircraft 30 may forward the instructions sent by the control side 20 for controlling the flight of the task aircraft 10 to the task aircraft 10, and may forward the image data sent by the task aircraft 10, the position, flight height, flight speed, flight acceleration, pitch angle of the task aircraft 10, and parameter information of the load carried by the task aircraft 10, etc., to the control side 20. During such period, the task aircraft 10 may be virtually connected to the control side 20. In other words, the task aircraft 10 may communicate with the control side 20, but the communication between the task aircraft 10 and the control side 20 may be merely synchronized at the physical layer. The communication data may not be transmitted to any other level above the physical layer.

In one embodiment, the first communication parameter, the second communication parameter, and the third communication parameter may be a sounding reference signal (SRS). In view of this, the task aircraft 10 and the control side 20 may send SRS signals to the relay aircraft 30, and the relay aircraft 30 may receive the SRS signals sent by the task aircraft 10 and the control side 20. At the same time, the task aircraft 10 may send the SRS signal to the control side 20, and the control side 20 may forward the received SRS signal sent by the task aircraft 10 to the relay aircraft 30. Thus, the relay aircraft 30 may calculate the first channel quality of the first communication link R1 according to the SRS signal (i.e., the first communication parameter) sent by the task aircraft 10 to the control side 20 and forwarded by the control side 20 to the relay aircraft 30. The relay aircraft 30 may calculate the second channel quality of the second communication link R2 according to the SRS signal (i.e., the second communication parameter) directly sent by the task aircraft 10 to the relay aircraft 30. The relay aircraft 30 may calculate the third channel quality of the third communication link R3 according to the SRS signal (i.e., the third communication parameter) directly sent by the control side 20 to the relay aircraft 30.

In certain embodiments, because the task aircraft 10 directly communicates with the relay aircraft 30, and the relay aircraft 30 directly communicates with the control side 20, the second communication parameter may be a signal, e.g., image transmission data, or flight parameter, etc., sent by the task aircraft 10. After receiving the signal, e.g., image transmission data, or flight parameter, etc., the relay aircraft 30 may calculate the second channel quality. The third communication parameter may be instruction signals sent by the control side 20. After receiving the instruction signals, the relay aircraft 30 may calculate the third channel quality.

After obtaining the first channel quality, the second channel quality, and the third channel quality, the relay aircraft 30 may compare the magnitudes of the three channel qualities. When the first channel quality is simultaneously greater than the second channel quality and the third channel quality, the relay aircraft 30 in the relay mode may have a communication quality lower than in the direct mode. In view of this, the relay aircraft 30 may stop relaying the instruction signals of the control side, and the task aircraft 10 may directly communicate with the control side 20, to ensure the stability and reliability of the communication between the task aircraft 10 and the control side 20.

The channel quality may be at least one of a signal noise ratio (SNR), a reference signal receiving power (RSRP), or a received signal strength indication (RSSI). In other words, the channel quality may be measured according to the signal noise ratio, may be measured according to the reference signal receiving power, or may be measured according to the received signal strength indication. In another embodiment, the channel quality may be measured according to both the signal noise ratio and the reference signal receiving power, may be measured according to both the signal noise ratio and the received signal strength indication, or may be measured according to both the reference signal receiving power and the received signal strength indication. In certain embodiments, the channel quality may be measured according to the signal noise ratio, the reference signal receiving power, and the received signal strength indication. When the channel quality is collectively measured according to more of the signal noise ratio, the reference signal receiving power, and the received signal strength indication, same or different weights may be configured for each participated measurement index. Further, the signal noise ratio, the reference signal receiving power, and the received signal strength indication may be calculated through communication parameters.

Referring to FIG. 2 and FIG. 11, in certain embodiments, the control method for the relay aircraft 30 in the disclosed embodiments of the present disclosure may further include the following.

In S35: When the task aircraft 10 is flying in the direct mode, if the first channel quality is merely lower than the second channel quality or the first channel quality is merely lower than the third channel quality, controlling the relay aircraft 30 to maintain stopping relaying the instructions of the control side 20.

In S36: When the task aircraft 10 is flying in the relay mode, if the first channel quality is merely greater than the second channel quality or the first channel quality is merely greater than the third channel quality, controlling the relay aircraft 30 to maintain relaying the instructions of the control side 20 to control the flight of the task aircraft 10.

Referring to FIG. 2, in certain embodiments, steps S35 and S36 may be achieved by the processor 31. In other words, when the task aircraft 10 is flying in the direct mode, if the first channel quality is merely lower than the second channel quality or the first channel quality is merely lower than the third channel quality, the processor 31 may be configured to control the relay aircraft 30 to maintain stopping relaying the instructions of the control side 20. When the task aircraft 10 is flying in the relay mode, if the first channel quality is merely greater than the second channel quality or the first channel quality is merely greater than the third channel quality, the processor 31 may be configured to control the relay aircraft 30 to maintain relaying the instructions of the control side 20 to control the task aircraft 10 to fly.

In one embodiment, the first channel quality being merely lower than one of the second channel quality and the third channel quality, and the first channel quality being merely greater than one of the second channel quality and the third channel quality may belong to a case where the first channel quality is between the second channel quality and the third channel quality. In view of this, the relay aircraft 30 may maintain the original operation mode regardless of whether the task aircraft 10 operates in the direct mode or in the relay mode. Therefore, the relay aircraft 30 may be prevented from frequently switching operation mode to increase the processing load of the communication component 32.

Referring back to FIG. 3, in certain embodiments, when the relay aircraft 30 is a relay unmanned aerial vehicle, the relay unmanned aerial vehicle may be controlled by a controller 40. There may be a fourth communication link R4 between the relay unmanned aerial vehicle and the controller 40. The controller 40 may send control instructions for controlling the flight of the relay unmanned aerial vehicle through the fourth communication link R4. In addition, when the relay unmanned aerial vehicle does not relay the communication signal between the task aircraft 10 and the control side 20, the relay unmanned aerial vehicle may perform tasks, e.g., assisting the task aircraft 10 to photograph image transmission data, performing line inspection, etc., under the control of the controller 40. The relay unmanned aerial vehicle may send the collected data to the controller 40. In view of this, the relay unmanned aerial vehicle may not only have the relay function, but also assist the task aircraft 10 to perform tasks, thereby improving the execution efficiency of the tasks.

The present disclosure further provides a computer-readable storage medium. The computer-readable storage medium may include a computer program used in combination with an electronic device. The electronic device herein may be the relay aircraft 30. The computer program may be executed by the processor 31 to achieve the control method for the relay aircraft 30 according to any one of the above-disclosed embodiments.

In one embodiment, the computer program may be executed by the processor 31 to perform the following control method for the relay aircraft 30. When the communication quality under the relay mode is greater than the communication quality under the direct mode, the relay aircraft 30 may be controlled to relay the instructions of the control side 20 to control the task aircraft 10 to fly. When the communication quality under the relay mode is lower than the communication quality under the direct mode, the relay aircraft 30 may be controlled to stop relaying the instructions of the control side 20.

In another embodiment, the computer program may be executed by the processor 31 to perform the following control method for the relay aircraft 30.

The communication component 32 may be controlled to obtain a first communication parameter of the first communication link R1, a second communication parameter of the second communication link R2, and a third communication parameter of the third communication link R3.

The magnitudes of a first channel quality corresponding to the first communication link R1, a second channel quality corresponding to the second communication link R2, and a third channel quality corresponding to the third communication link R3 may be determined, according to the first communication parameter, the second communication parameter, and the third communication parameter, respectively.

When the first channel quality is greater than the second channel quality, and the first channel quality is greater than the third channel quality, it may be determined that the communication quality under the relay mode is lower than the communication quality under the direct mode.

When the first channel quality is lower than the second channel quality, and the first channel quality is lower than the third channel quality, it may be determined that the communication quality under the relay mode is greater than the communication quality under the direct mode.

In the description of present disclosure, the description of terms “one embodiment”, “some embodiments”, “schematic embodiments”, “examples”, “specific examples”, or “some examples”, etc., may refer to specific features, structures, materials, or characteristics described in combination with the disclosed embodiments or examples and included in at least one embodiment or example of the present disclosure. In the present disclosure, the schematic expressions of the above terms may not necessarily refer to a same embodiment or example. Moreover, the described specific features, structures, materials, or characteristics may be combined in any suitable manner in any one or more embodiments or examples.

Any process or method described in a flowchart or otherwise described herein may be understood as including one or more of a component, fragment, or portion of code of executable instruction that is used to perform steps of a particular logical function or a process. In the disclosed embodiments of the present disclosure, the steps may be performed out of the illustrated or discussed order. According to the related functions, the functions may be performed in a substantially simultaneous manner or a reverse order.

Logic and/or steps described in the flowchart or otherwise described herein may be a sequenced list of executable instructions used to perform the logical function, and may be performed in any computer-readable medium for use in one or more of an instruction execution system, device, or apparatus (e.g., a computer-based system, a system including a processor, or any other system capable of obtaining the instruction from the instruction execution system, device, or apparatus and performing the instruction). In the present disclosure, the “computer-readable medium” may be any device that may contain, store, communicate, propagate, or transmit a program for use by one or more of the instruction execution system, device, or apparatus. Specific examples (non-exhaustive list) of the computer-readable medium may include the following: an electrical connection (an electronic device) with one or more wirings, portable computer disk cartridges (a magnetic device), a random access memory (RAM), a read-only memory (ROM), an erasable and editable read-only memory (EPROM or flash memory), a fiber optic device, and portable optical disk read-only memory (CDROM). In addition, the computer-readable medium may even be paper or any other suitable medium on which the program can be printed. By optically scanning the paper or any other medium, and then performing an edit, interpretation, or any other suitable process, the program may be obtained through an electronic manner, and then may be stored in the computer memory.

Each part of the present disclosure may be executed by hardware, software, firmware, or a combination thereof. In the above-disclosed embodiments, the plurality of steps or methods may be performed by software or firmware stored in the memory and executed by a suitable instruction execution system. For example, if the steps or methods are executed by hardware, the steps or methods may be executed by any one or a combination of the following: a separate logic circuit including a logic gate circuit used to perform a logic function on a data signal, an application-specific integrated circuit with suitable combinational logic gate circuits, a programmable gate array (PGA), a field programmable gate array (FPGA), etc.

Those skilled in the art can understand that performing all or part of the steps carried out in the foregoing embodiments can be performed by a related hardware instructed by a program. The program can be stored in a computer-readable storage medium, and when being executed, the program may include one or a combination of the steps in the disclosed embodiments.

In addition, each functional unit in each embodiment of the present disclosure may be integrated into one processing component, or each functional unit may be separately physically provided. Alternatively, two or more units may be integrated into one component. The above integrated component can be executed in the form of hardware or a software functional components. When the integrated component is executed in the form of the software functional component, and sold or used as an independent product, the integrated component may be stored in a computer-readable storage medium. The aforementioned storage medium may be a read-only memory, a magnetic disk, or an optical disk.

The above detailed descriptions only illustrate certain exemplary embodiments of the present disclosure, and are not intended to limit the scope of the present disclosure. Those skilled in the art can understand the specification as whole and technical features in the various embodiments can be combined into other embodiments understandable to those persons of ordinary skill in the art. Any equivalent or modification thereof, without departing from the spirit and principle of the present disclosure, falls within the true scope of the present disclosure.

What is claimed is:

1. A control method for a task aircraft, wherein the task aircraft flies in an initial mode; the initial mode includes one of a direct mode and a relay mode; in the direct mode, the task aircraft flies under a direct control of a control side; and in the relay mode, the task aircraft flies under a control of instructions of the control side relayed by a relay aircraft, the control method comprising:
controlling the task aircraft to fly in the direct mode, when a communication quality under the relay mode is lower than a communication quality under the direct mode, or
controlling the task aircraft to fly in the relay mode, when a communication quality under the relay mode is greater than a communication quality under the direct mode.

2. The control method according to claim 1, wherein:
a first communication link is between the task aircraft and the control side, a second communication link is between the task aircraft and the relay aircraft, a third communication link is between the relay aircraft and the control side, and
the control method further includes:
obtaining a first communication parameter of the first communication link, a second communication parameter of the second communication link, and a third communication parameter of the third communication link,
determining magnitudes of a first channel quality corresponding to the first communication link, a second channel quality corresponding to the second communication link, and a third channel quality corresponding to the third communication link, according to the first communication parameter, the second communication parameter, and the third communication parameter, respectively, and
when the first channel quality is greater than the second channel quality, and the first channel quality is greater than the third channel quality, determining that the communication quality under the relay mode is lower than the communication quality under the direct mode, or
when the first channel quality is lower than the second channel quality, and the first channel quality is lower than the third channel quality, determining that the communication quality under the relay mode is greater than the communication quality under the direct mode.

3. The control method according to claim 2, wherein:
a channel quality includes one or more of a signal noise ratio, a reference signal receiving power, and a received signal strength indication.

4. The control method according to claim 2, further including:
when the task aircraft is flying in the direct mode, if the first channel quality is merely lower than the second channel quality or the first channel quality is merely lower than the third channel quality, controlling the task aircraft to maintain flying in the direct mode.

5. The control method according to claim 2, further including:
when the task aircraft is flying in the relay mode, if the first channel quality is merely greater than the second channel quality or the first channel quality is merely greater than the third channel quality, controlling the task aircraft to maintain flying in the relay mode.

6. The control method according to claim 1, wherein:
the relay aircraft includes a fixed relay station, a relay unmanned aerial vehicle, or a relay.

7. A control method for a control side, wherein the control side communicates with a task aircraft and a relay aircraft; the control side operates in an initial mode; the initial mode includes one of a direct mode and a relay mode; in the direct mode, the task aircraft is directly controlled to fly by the control side; and in the relay mode, the task aircraft is controlled to fly after being relayed through the relay aircraft, the control method comprising:
controlling the control side to operate in the direct mode, when a communication quality under the relay mode is lower than a communication quality under the direct mode, or
controlling the control side to operate in the relay mode, when a communication quality under the direct mode is lower than a communication quality under the relay mode.

8. The control method according to claim 7, wherein:
a first communication link is between the task aircraft and the control side, a second communication link is between the task aircraft and the relay aircraft, a third communication link is between the relay aircraft and the control side, and
the control method further includes:
obtaining a first communication parameter of the first communication link, a second communication parameter of the second communication link, and a third communication parameter of the third communication link,
determining magnitudes of a first channel quality corresponding to the first communication link, a second channel quality corresponding to the second communication link, and a third channel quality corresponding to the third communication link, according to the first communication parameter, the second communication parameter, and the third communication parameter, respectively, and
when the first channel quality is greater than the second channel quality, and the first channel quality is greater than the third channel quality, determining that the communication quality under the relay mode is lower than the communication quality under the direct mode, or
when the first channel quality is lower than the second channel quality, and the first channel quality is lower than the third channel quality, determining that the communication quality under the relay mode is greater than the communication quality under the direct mode.

9. The control method according to claim 8, wherein:
a channel quality includes one or more of a signal noise ratio, a reference signal receiving power, and a received signal strength indication.

10. The control method according to claim 8, further including:
when the control side is operating in the direct mode, if the first channel quality is merely lower than the second channel quality or the first channel quality is merely lower than the third channel quality, controlling the control side to maintain operating in the direct mode.

11. The control method according to claim 8, further including:
when the control side is operating in the relay mode, if the first channel quality is merely greater than the second channel quality or the first channel quality is merely greater than the third channel quality, controlling the control side to maintain operating in the relay mode.

12. The control method according to claim 7, wherein:
the relay aircraft includes a fixed relay station, a relay unmanned aerial vehicle, or a relay.

13. A control method for a relay aircraft, wherein the relay aircraft communicates with a task aircraft and a control side; the task aircraft flies in an initial mode; the initial mode includes one of a direct mode and a relay mode; in the direct mode, the task aircraft flies under a direct control of the control side; and in the relay mode, the task aircraft flies under a control of instructions of the control side relayed by the relay aircraft, the control method comprising:
controlling the relay aircraft to relay the instructions of the control side to control the task aircraft to fly, when a communication quality under the relay mode is greater than a communication quality under the direct mode, or
controlling the relay aircraft to stop relaying the instructions of the control side, when a communication quality under the relay mode is lower than a communication quality under the direct mode.

14. The control method according to claim 13, wherein:
a first communication link is between the task aircraft and the control side, a second communication link is between the task aircraft and the relay aircraft, a third communication link is between the relay aircraft and the control side, and
the control method further includes:
obtaining a first communication parameter of the first communication link, a second communication parameter of the second communication link, and a third communication parameter of the third communication link,
determining magnitudes of a first channel quality corresponding to the first communication link, a second channel quality corresponding to the second communication link, and a third channel quality corresponding to the third communication link, according to the first communication parameter, the second communication parameter, and the third communication parameter, respectively, and
when the first channel quality is greater than the second channel quality, and the first channel quality is greater than the third channel quality, determining that the communication quality under the relay mode is lower than the communication quality under the direct mode, or
when the first channel quality is lower than the second channel quality, and the first channel quality is lower than the third channel quality, determining that the communication quality under the relay mode is greater than the communication quality under the direct mode.

15. The control method according to claim 14, wherein:
a channel quality includes one or more of a signal noise ratio, a reference signal receiving power, and a received signal strength indication.

16. The control method according to claim 14, further including:
when the task aircraft is flying in the direct mode, if the first channel quality is merely lower than the second channel quality or the first channel quality is merely lower than the third channel quality, controlling the relay aircraft to maintain stopping relaying the instructions of the control side.

17. The control method according to claim 14, further including:
when the task aircraft is flying in the relay mode, if the first channel quality is merely greater than the second channel quality or the first channel quality is merely greater than the third channel quality, controlling the relay aircraft to maintain relaying the instructions of the control side to control the task aircraft to fly.

18. The control method according to claim 13, wherein:
the relay aircraft includes a fixed relay station, a relay unmanned aerial vehicle, or a relay.
